(19) United States
(12) Patent Application Publication
(10) Pub. No.: US 2009/0223052 A1
(43) Pub. Date: Sep. 10, 2009

(54) GEARBOX GEAR AND NACELLE ARRANGEMENT

(76) Inventors: Zaffir A. Chaudhry, South Glastonbury, CT (US); Mark R. Jaworowski, Glastonbury, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/041,732

(22) Filed: Mar. 4, 2008

(51) Int. Cl. B23P 15/04

(52) U.S. Cl. 29/889.2; 148/222; 60/226.1

(57) ABSTRACT

A gas turbine engine is provided that includes a spool that supports an engine. A gearbox is operatively coupled to the spool through a transmission device configured to transfer rotational drive from the spool to the gearbox. An accessory drive component is coupled to the gearbox. The gearbox is arranged radially between the gas turbine engine and a nacelle that is arranged about the gas turbine engine. A gear is supported by the gearbox and configured to transmit rotational drive to the accessory drive component. The gear includes an iron alloy having a strength of approximately 1900 MPa or greater and a shear fracture toughness of 130 MPa\sqrt{M} or greater in one example. The gears have teeth with a case hardness of approximately 44 HRC or greater. The teeth have a surface finish of less than 16μ/in.

### BACKGROUND

This disclosure generally relates to a gas turbine engine. More particularly, the disclosure relates to gears for a gearbox, which has a nacelle arranged about the gearbox.

Gas turbine engines for commercial aircraft applications typically include an engine core housed within a core nacelle. In one type of arrangement known as a turbofan engine, the core drives a large fan upstream from the core that provides airflow into the core. One or more spools are arranged within the core, and a gear train may be provided between one of the spools and the fan. A fan case and nacelle surround the fan and at least a portion of the core.

An inlet of the fan nacelle is designed to avoid flow separation. At cruise conditions, a thinner inlet lip is desired to minimize drag and increase fuel economy. The nacelles are sized to accommodate the widest section of engine, which is often dictated by the size of an accessory drive gearbox. The accessory drive gearbox, which is driven by a spool through a radial tower shaft and angle gearbox, is typically contained within either the fan nacelle or the core nacelle. The gearbox is sized to accommodate gears used to drive the accessory components. The gears must be durable enough to withstand the power transmitted through them without excessive bending, galling or pitting.

Typically, carburized steel gears are used in gearboxes. Helicopter gearboxes are subject to stringent noise, weight and vibration limitations. To address these limitations, the gears have been nitrided, thus enabling smaller gears to be used thereby reducing the weight of the gearbox. Helicopter gearbox gears separately have been superfinished to reduce bending and pitting. However, gearbox noise and weight and other helicopter gear issues traditionally have not been issues for airplane gas turbine engine applications.

What is needed is a gas turbine engine design with a reduced diameter nacelle, which houses a smaller accessory drive gearbox.

### SUMMARY

A gas turbine engine is provided that includes a spool that supports a turbine. A gearbox is operatively coupled to the spool through a transmission device configured to transfer rotational drive from the spool to the gearbox. An accessory drive component is coupled to the gearbox. The gearbox is arranged radially between the gas turbine engine and a nacelle that is arranged about the gas turbine engine.

A gear is supported by the gearbox and configured to transmit the rotational drive to the accessory drive component. The gear includes an iron alloy having a strength of approximately 1150 MPa or greater and a shear fracture toughness of 100 MPa\sqrt{M} or greater. In one example, the iron alloy has a strength of greater than 1900 MPa and a shear fracture toughness of greater than 130 MPa\sqrt{M} The gears have teeth with a case hardness of approximately 44 HRC or greater in one example. The teeth have a surface finish of less than 16μ/in., for example.

These and other features of the disclosure can be best understood from the following specification and drawings, the following of which is a brief description.

### BRIEF DESCRIPTION OF THE DRAWINGS

FIG. 1 is a highly schematic view of a turbofan gas turbine engine.

FIG. 2a is a front perspective view of an accessory drive gearbox.

FIG. 2b is a rear perspective view of the accessory drive gearbox shown in FIG. 2a.

FIG. 3 is a schematic view of gas turbine accessory drive gearbox gears according to one example of this disclosure.

### DETAILED DESCRIPTION

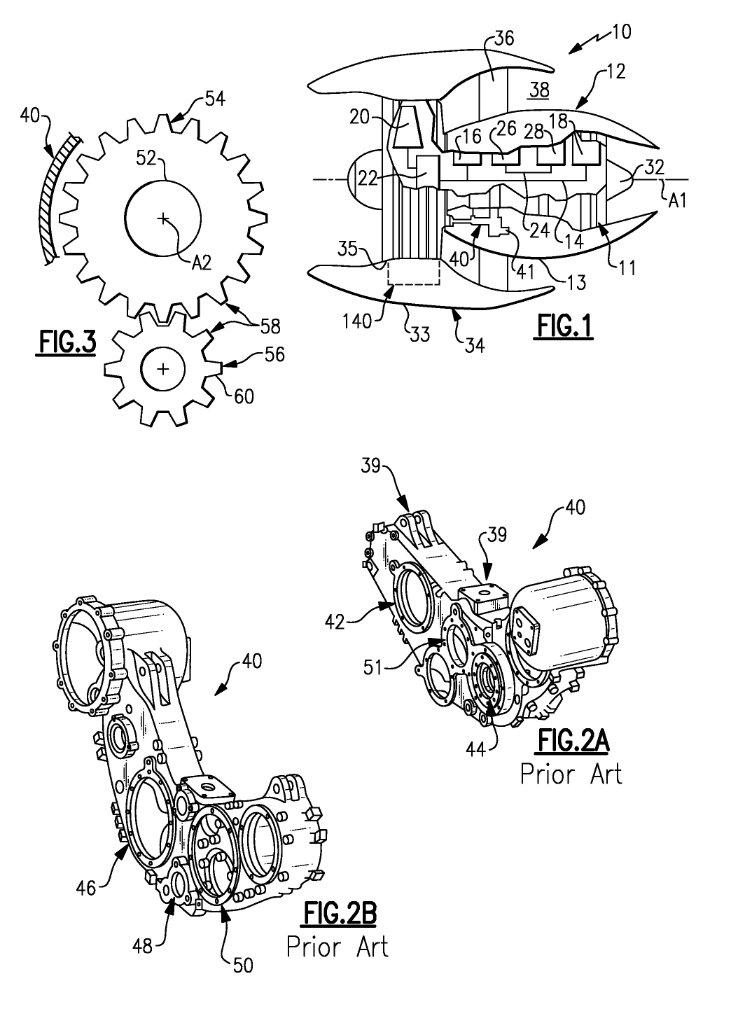

An engine 10 with geared architecture is shown in FIG. 1. A pylon typically secures the engine 10 to an aircraft. The engine 10 includes a core nacelle 12 that surrounds a low spool 14 and high spool 24 that are rotatable about a common axis A1. The low spool 14 supports a low pressure compressor 16 and low pressure turbine 18. In the example, the low spool 14 drives a fan 20 through a gear train 22. The high spool 24 supports a high pressure compressor 26 and high pressure turbine 28. A combustor (not shown) is arranged between the high pressure compressor 26 and high pressure turbine 28. Compressed air from compressors 16, 26 mixes with fuel from the combustor 30 and is expanded in turbines 18, 28.

In the example shown, the engine 10 is a high bypass turbofan arrangement. In one example, the bypass ratio is greater than 10, and the turbofan diameter is substantially larger than the diameter of the low pressure compressor 16. The low pressure turbine 18 has a pressure ratio that is greater than 5:1, in one example. The gear train 22 is an epicycle gear train, for example, a star gear train, providing a gear reduction ratio of greater than 2.5:1, for example. It should be understood, however, that the above parameters are only exemplary of a contemplated geared architecture engine. That is, the invention is applicable to other engines including direct drive turbofans.

Airflow enters a fan nacelle 34, which surrounds the core nacelle 12 and fan 20. The fan 20 directs air into the core nacelle 12, which is used to drive the turbines 18, 28, as is known in the art. Turbine exhaust exits the core nacelle 12 once it has been expanded in the turbines 18, 28, in a passage provided between the core nacelle 12 and a tail cone 32.

A core housing 11 is arranged within the core nacelle 12 and is supported within the fan nacelle 34 by structure 36, such as flow exit guide vanes. A generally annular bypass flow path 38 is arranged between the core and fan nacelles 12, 34. The examples illustrated in the Figures depict a high bypass flow arrangement in which approximately eighty percent of the airflow entering the fan nacelle 34 bypasses the core nacelle 12. The bypass flow within the bypass flow path 38 exits the fan nacelle 34 through a fan nozzle exit area at the aft of the fan nacelle 34.

In the example shown in FIG. 1, accessory drive gearboxes 40, 140 used to drive accessory components are schematically illustrated at different location within the engine. Unlike a helicopter gearbox, an aircraft gearbox is subject to temperatures above 300° F., which has a significant negative impact on gear life. Large gears have been used to survive in these temperatures. In one example, one accessory drive gearbox 40 is arranged in a radial space between the fan case 35 and an exterior surface 33 of the fan nacelle 34. An accessory drive component 41 is shown schematically mounted on the gearbox 40. Alternatively, an accessory drive gearbox 140 is arranged in a radial space between the core housing 11 and an exterior surface 13 of the core nacelle 12. Accessory drive gearboxes 40, 140 can be housed within either nacelle or both, if desired.

A prior art gearbox 40 is shown in FIGS. 2a and 2b. The gearbox 40 includes mounts 39 for securing the gearbox 40 to the engine 10. Example accessory drive components are: a fuel pump, hydraulic pump, generator and lubrication pump. The mounting pads for the accessory drive components indicated above are respectively provided at 42, 44, 46, 48. An input shaft mounting pad is illustrated at 51.

The gearbox 40 includes first and second gears 54, 56 that are schematically shown in FIG. 3. The gears have an axis A2 that is parallel with the axis A1. The first and second gears 54, 56 include teeth 58 having surfaces 60. The first and second gears 54, 56 transmit rotational drive from a spool to an accessory drive component. As can be appreciated from the figures, as the size of the first and second gears 54, 56 and other gears within the gearbox 40 increases, the size of the gearbox 40 also increases thus increasing the circumference of the nacelle that houses the gearbox. To this end, it is desirable to reduce the size of the gearbox gears, thereby decreasing the size of the nacelle that is needed to accommodate the gearbox. In one disclosed embodiment, first a suitable alloy is selected having a desired toughness. Secondly, the alloy is case-hardened. Thirdly, the case-hardened alloy is superfinished.

In one example, an iron alloy is used to form the gears. It is desirable to provide a high strength, high toughness material, which enables to the size of the gear to be reduced. Example iron alloys with high strength and toughness contain nickel, cobalt, chromium, molybdenum, and carbon. One example iron alloy has a strength of approximately 1150 MPa or greater and a shear fracture toughness of approximately 100 MPa\sqrt{M} or greater. In another example, the iron alloy has a strength of approximately 1900 Pa or greater and a shear fracture toughness of approximately 130 MPa\sqrt{M} or greater. In one example, the gears are manufactured from AerMet 100 or AerMet 310, available from Carpenter Technologies. In another example, the gears are manufactured from Ferrium C69, available from Questek. Pyrowear 53 is another example iron alloy. The above-listed alloys are exemplary only.

Other suitable iron alloys can be selected according to U.S. application Ser. Nos. 10/937,004 and 10/937,100, which are incorporated by reference. The iron alloys avoid disadvantages associated with typical gear alloys that have a low softening point and must be case-hardened at temperatures much greater than their tempering point. This results in distortion, which requires significant final machining. It is desirable to avoid machining after case-hardening in which material must be removed from the gear teeth to achieve desired dimensions.

The size of the gears can also be reduced by increasing the case hardness of the gear. High strength and toughness alloys, such as AerMet 100, cannot withstand airplane gearbox conditions. Accordingly, the gears 54, 56 can be carburized or nitrided to increase the hardness of the surface 60 to approximately 44 HRC or greater. In one example, the core hardness of the gears is approximately 52 HRC and the surface hardness is approximately 60-62 HRC after carburizing. Ion nitriding the surface 60 can result in a hardness of greater than 65 HRC in one example.

Alloy selection and hardening, such as nitriding, can eliminate post-process machining thereby greatly reducing manufacturing costs. By employing plasma/ion nitriding according to exemplary methods disclosed in U.S. application Ser. Nos. 10/937,004; 10/870,489; and 10/937,100, which are incorporated by reference, desired case hardening can be achieved. For example, one desired surface treatment uses a high current density ion implantation that results in a case depth of 12 microns without distorting the part or producing a surface white layer that must be removed by subsequent machining.

Typically, the ground surface finish of an airplane gearbox gear is 16μ/in. Isotropic superfinishing can be employed to improve the surface characteristics of the gears 54, 56 thereby further enabling the size of the gears to be reduced. In one example, isotropic superfinishing processes can be employed. For example, the gear can be agitated in a vibrating finisher using an aqueous mixture of sodium bisulfate, monosodium phosphate, potassium dichromate and potassium phosphate to obtain an isotropic superfinish. In another example, oxalic acid, sodium nitrate and hydrogen peroxide can be used in the vibratory finisher. Bending, pitting and scoring of the gear teeth thereby can be reduced. Isotropic superfinishing can achieve a finish of 3μ/in.

By using a suitable iron alloy, such as Aermet 100 (which has also been case-hardened), and employing isotropic superfinishing, the power density of the gears can be increased by 53% in one example.

Although an example embodiment has been disclosed, a worker of ordinary skill in this art would recognize that certain modifications would come within the scope of the claims. For that reason, the following claims should be studied to determine their true scope and content.

What is claimed is:

1. A method of manufacturing a gas turbine engine comprising the steps of:
providing an iron alloy gear;
case-hardening teeth on the gear;
isotropicly superfinishing the teeth;
installing the superfinished, case-hardened alloy gear into a gearbox; and
mounting the gearbox to a gas turbine engine.

2. The method according to claim 1, wherein the iron alloy gear includes nickel, cobalt, chromium, molybdenum and carbon.

3. The method according to claim 2, wherein the case-hardening step includes plasma nitriding the gear.

4. The method according to claim 3, wherein the superfinishing step provides a surface finish of less than 16μ/in.

5. The method according to claim 4, wherein the superfinishing step is performed after the case-hardening step without dimensionally machining the teeth.

6. The method according to claim 2, wherein the iron alloy includes a shear fracture toughness of approximately greater than 100 MPa\sqrt{M}.

7. The method according to claim 6, wherein the iron alloy includes a shear fracture toughness of approximately 130 MPa\sqrt{M} or more.

8. The method according to claim 1, comprising the step of installing a nacelle about the gas turbine engine with the gearbox arranged radially between the gas turbine engine and the nacelle, the gear and gas turbine engine having parallel axes.

9. A gas turbine engine gearbox gear comprising:
a gear including an iron alloy having a strength of approximately 1150 MPa or greater and a shear fracture toughness of approximately 130 MPa\sqrt{M} or greater, the gear having teeth including a case hardness of approximately 44 HRC or greater, the teeth having a surface finish of approximately 16μ/in. or less.

10. The gas turbine engine gearbox gear according to claim 9, wherein the iron alloy gear includes nickel, cobalt, chromium, molybdenum and carbon.

11. The gas turbine engine gearbox gear according to claim 9, wherein the case hardness extends a depth of 12 microns from a surface of the gear.

12. The gas turbine engine gearbox gear according to claim 9, wherein the case hardness is greater than 60 HRC.

13. The gas turbine engine gearbox gear according to claim 10, wherein the case hardness is greater than 65 HRC.

14. The gas turbine engine gearbox gear according to claim 9, wherein the surface finish is approximately 3μ/in.

15. The gas turbine engine gearbox gear according to claim 9, wherein the shear fracture toughness is greater than approximately 130 MPa\sqrt{M}.

16. The gas turbine engine gearbox gear according to claim 9, wherein the strength is greater than approximately 1900 MPa.

17. A gas turbine engine comprising:
a spool that supports a turbine;
a gearbox operatively coupled to the spool through a transmission device configured to transfer rotational drive from the spool to the gearbox, an accessory drive component coupled to the gearbox; and
a gear supported by the gearbox and configured to transmit rotational drive to the accessory drive component, the gear including an iron alloy having a strength of approximately 1900 MPa or greater and a shear fracture toughness of approximately 130 MPa\sqrt{M} or greater, the gear having teeth including a case hardness of approximately 44 HRC or greater, the teeth having a surface finish of approximately 16μ/in. or less.

18. The gas turbine engine gearbox gear according to claim 17, wherein the iron alloy gear includes nickel, cobalt, chromium, molybdenum and carbon.

19. The gas turbine engine gearbox gear according to claim 17, wherein the case hardness extends a depth of 12 microns from a surface of the gear.

20. The gas turbine engine gearbox gear according to claim 17, wherein the case hardness is greater than 60 HRC.

21. The gas turbine engine gearbox gear according to claim 20, wherein the case hardness is greater than 65 HRC.

22. The gas turbine engine gearbox gear according to claim 17, wherein the surface finish is approximately 3μ/in.
